(19) United States
(12) Patent Application Publication
(10) Pub. No.: US 2005/0171922 A1
(43) Pub. Date: Aug. 4, 2005

(54) Method and apparatus for printing addresses in a franking system

(76) Inventors: Brian Leary, Milford, CT (US); George Hesse, Trumbull, CT (US); Michael Keenan, Wilton, CT (US); Graham Fulghum, Reston, VA (US)

Correspondence Address: PERMAN & GREEN, 425 POST ROAD, FAIRFIELD, CT, 06824, US

(21) Appl. No.: 10/768,891

(22) Filed: Jan. 30, 2004

(51) Int. Cl. G06F 17/60

(52) U.S. Cl. 705/408

(57) ABSTRACT

A franking system is provided having a franking meter that operates in association with a security device and a printer to apply shipping charge indicium and addresses to a mail item or label. A control processor executes software from memory to accomplish the postage and addressing function. The control processor is provided with means to access address database resident in an external database to check and update addresses selected for printing.

### BACKGROUND OF THE INVENTION

1. Field of the Invention

The present invention relates to postage meters and the like with digital printing capability. More particularly a system is provided for printing franking indicium and addresses via a franking meter.

2. Brief Description of Related Developments

Postage meters have been utilized over a long period to print postage indicia on mail items. The postage indicia indicates that postage has been applied to the mail item and that accounting has been effected in respect of the applied postage. Conventionally the postal meter can be leased or rented from commercial enterprises set up for that purpose. Known postage meters include an electronic circuit for carrying out accounting functions in relation to amounts of postage charges applied to mail items. The electronic circuit receives an input of a desired postage charge to be applied to a mail item, carries out accounting in respect of the required postage charge and then operates a printer of the postage meter to print a postage indicium on the mail item. Generally the postage indicium includes at least the postage charge, the date on which the indicium is printed and an identification of the postage meter.

The postage meter is generally constructed in a secure manner by being enclosed in a secure housing. The printer is constructed to work integrally with the meter and also is secure. Accordingly the indicia is printed under conditions of security and attempts to operate the meter and printer in a fraudulent manner are minimized.

Postage meters currently available are provided with a digital printer. The digital printer is controlled by the electronic circuit of the postage meter to print in a series of cycles a pattern of dots to form the complete indicium. It will be appreciated that, whereas the indicium printed by the drum printer of earlier postage meters is invariable, apart from the value of postage charge and date, the digital printer of currently available postage meters is capable of printing additional information, such as addresses.

It a purpose of this invention to provide a system and method for printing addresses on an envelopes as well as applying postage indicium.

Since, according to this invention, addressing envelopes includes the application of postage, there is increased cost involved in address mistakes and less opportunity to check the address for accuracy, prior to application of postage. It is a purpose of this invention to provide a postage meter system that has the ability to check addresses against an up to date resource.

One such resource is provided by the US Postal Service through its online database of current addresses available at its web site. It is a purpose of this invention to provide a communication interlink to allow checking of addresses with up to date data such as the USPS database or other third party commercial Internet services.

With the emergence of commercial shipping and delivery enterprises that compete with the USPS, the postage meters discussed above are also adapted to provide payment information for such other shippers. In describing the system of this invention, the word franking will be used so as to include all shipping entities, such as the USPS, UPS, FEDEX, AIRBORNE, and others providing similar services.

### SUMMARY OF THE INVENTION

A franking system is provided having a postage meter that operates in association with a security device and a printer to apply postage in a secure and accountable procedure. The postage meter is coupled to a control processor for executing software to accomplish a variety of tasks. The postal security device is a secure processor-based accounting device that dispenses and accounts for postal value stored within postage meter.

The printer of this system is a digital printer, such as an ink jet, laser printer, or direct thermal printer and is capable of printing postage indicia and other text, such as addresses.

A user interface, that includes a keypad and a display allows the entering of instructions and data to the control processor and the franking machine. Software modules are resident in a memory accessible by the control processor and constructed to control and execute the functions of the franking machine and printer.

The control processor is connected through a communication link to an Internet server through which certain databases, containing accurate and up to date address information, may be accessed. Provision is made to allow the Internet address to be made through a personal computer, personal data assistant, or other device. In addition a third party server could be used to provide a more secure communication. This would be accomplished over a phone line or other secure direct link.

### BRIEF DESCRIPTION OF THE DRAWINGS

The foregoing aspects and other features of the present invention are explained in more detail below with reference to the following drawing in which:

FIG. 1 is a block diagram of a franking system according to this invention; and

FIG. 2 is a flow diagram of the method of this invention.

### DETAILED DESCRIPTION OF THE PREFERRED EMBODIMENTS

In the system of this invention, a franking system 20 is constructed having a franking meter 1 operatively associated with a printer 3 and a shipping security device 12. Control processor 4 operates the meter 1 by executing software resident in memory 5 and designed to perform multiple tasks. The franking system 20 further comprises a user interface 2 having a keypad and a display for entering data and providing operating information. In addition a communication link 6, such as a modem, is provided to access an Internet server 7. This link may also be a direct phone link 17 that connects directly to other commercial servers for increased security.

The Internet server 7 or other server (not shown) is used to access address databases in particular the US Postal Service, address database. This is a database which is continually updated for latest used addresses of individuals and companies. It contains a listing of the most up to date record of Postal Service customers. Similar databases, such as third party database 9, based on other information resources are available and would also be accessible through the Internet or other secure direct phone link 17. In addition the franking system 20 is constructed with means to connect to the Internet or other link through a personal computer 11, personal digital assistant 10, or other device to facilitate Internet access and database interface.

Franking system 20 would also be connected through communication link 5 to a shipper server 18 to send shipping data, including destination, routing, delivery, and tracking information as well as charges to the shipping service used.

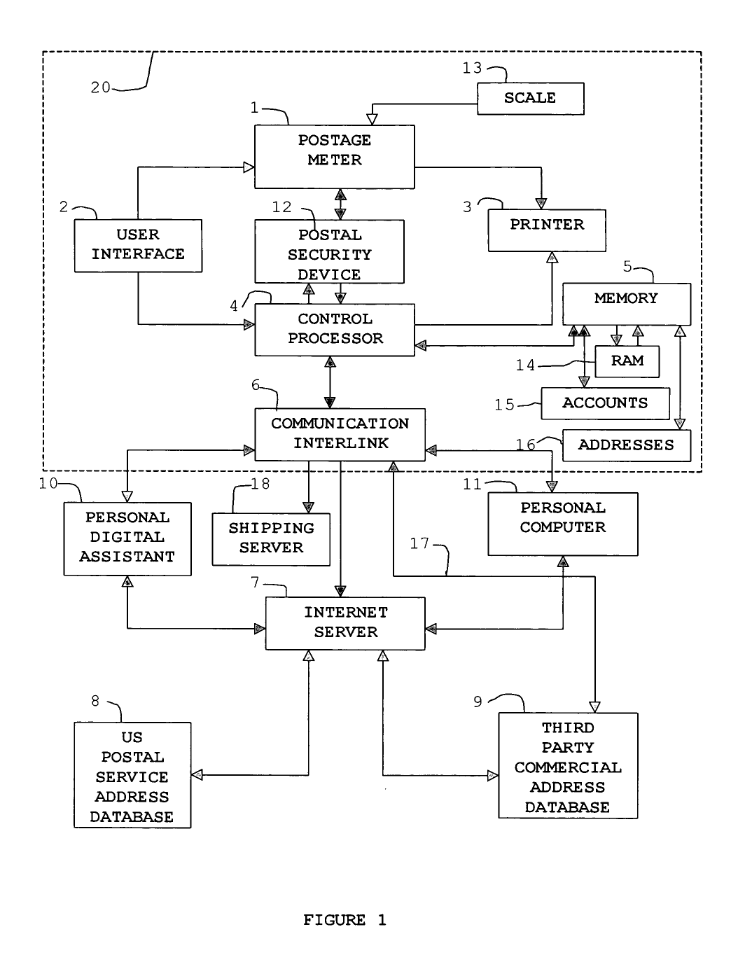

Franking meter 1 and its associated shipping security device 12 may comprise any state of the art unit for applying postage or other shipping payment indicium to a mail item and authenticating its use. Generally the indicium includes at least the charges, the date on which the indicium is printed and an identification of the franking meter. In addition an accounting of charges applied is maintained on a continuing basis. Although it is indicated in FIG. 1 as two modules, it may be a single module. In addition, the operation may be controlled by control processor 4. The shipping security device controls the application of the payment indicium in a manner that can be authenticated in any one of a number of processes well known in the prior art. A scale 13, which preferably has an electronic output, may be connected to the meter 1 for direct entering of the weight of a mail item for use in the calculation of charges to be applied.

The printer may be any digital printer, such as an ink jet, laser printer, or direct thermal printer adapted to apply payment indicium and address text. A printing system of this type is described in U.S. Pat. No. 6,438,529 which is specifically designed for this purpose. A standard printer may also be used coupled to appropriate printer drivers resident in memory 5. The printer may be connected to receive franking instructions from meter 1 or through control processor 4. Control processor 4 provides the necessary printer drivers and commands for printing addresses. As indicated below the mail item can take a variety of shapes and sizes. In some instances, therefore, it is more convenient to use shipping labels, and forms depending on the shipping service used.

Control processor 4 may be any of the widely available microprocessor which are capable of executing printing commands according to software which is resident on memory 5. Such software could also be implemented as firmware in the form of an ASIC that comprises a part of control processor 4. Memory 5 will support the operation of the franking system 20 and have algorithms stored therein for executing tasks, such as printing postage or shipping charges and addresses and compiling accounting history, customer address data, and customer accounting.

Memory 5 includes a random access memory (RAM) 14 that is provided for use as a working store for storage of temporary data during operation of the franking meter 1. This would include a buffer to support the checking operation described below. In addition, non-volatile duplicative memories 15 and 16 are provided for the storage of critical data relating to use of the franking meter and which is required to be retained even when the franking system 20 is not powered such as accounting history, customer accounts, and address database.

User interface 2 provides access for the user to control processor 4 and postage meter 1. In addition operational information in the form of menus, task status, and other items may be displayed for the user. A full text QWERTY style keyboard may be provided for the entering of data and commands. Alternatively, the keyboard could consist of a simple keypad, such as used with a mobile telephone or PDA adapted to obtain an address or series of addresses from a listing stored in memory 5. A search algorithm could be provided to facilitate the entry and selection of address data to be printed.

Recognizing that address and postage is printed at the same time, a checking algorithm is executed prior to printing. The checking algorithm operates to compare address information, that may be buffered for printing as part of memory 5, to an address contained in a resource database, such as the USPS unified address database. The comparison would result in corrections being made to the database resident in memory 5. In this way an up to date listing may be maintained in memory 5. This process may be done for each postage transaction or on batch basis for the entire customer database on the franking system 20 depending on the volume of mail items being processed.

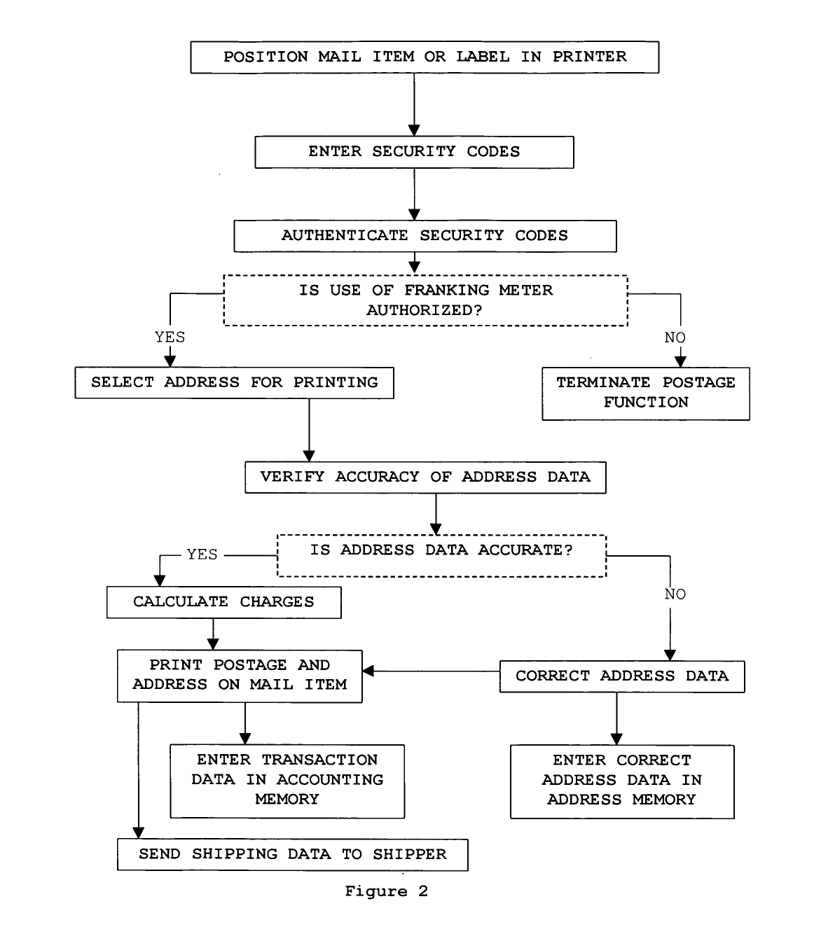

The operation of the system of this invention is shown in FIG. 2. An item or series of mail items are fed into the system, either directly to the printer 3, or through an appropriate feed mechanism (not shown) . Operation of the franking module 1 is initiated by means of personal identity codes entered by the customer using interface 2. A security algorithm, executable in control processor 4, checks the authenticity of the security identity codes and either authorizes a printing operation or ends the process. Such security algorithms are well known. If the transaction is authorized, an address check routine is executed. This routine would include accessing an external database to compare the addresses selected for printing with the up to date address resource. If the address is correct, the printer 3 is then instructed by control processor 4 to apply postage indicium and an address to the mail item or items. If the address is incorrect, it may then be corrected before printing. In the latter instance the internal address database in memory 16 would be updated. When the process is complete the shipping data is transmitted by communication link 6 to the shipper server 18.

To accommodate other shipping operations, the controller 4 may provide commands to the printer 3 to print addresses in accordance with form shipping labels consistent with the practice of other mail services such as FEDEX, Airborne, UPS and others. In addition franking system 20 is adapted to print coded information for routing, delivery, and tracking within the various mail services. These codes would depend on the shipping service use and may be in the form of bar codes, for example Postnet bar codes for routing mail, and the like that are machine readable. It is intended therefore, that the word address wherever used will include destination information of all types including coded routing, delivery and tracking indicium. Also it is intended that mail items include not only envelopes of all sizes, also parcels of all sizes.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A franking system for printing a mail item with shipping charges and address comprising:
a franking meter constructed to calculate and apply shipping charges indicium onto mail items or label;
a user interface for entering security codes and address data and selecting addresses;
a security device constructed to verify the authenticity of entered security codes;
a digital printer capable of printing shipping charges indicium and address data on a mail item or label;
a communication interlink for accessing an external database containing accurate address data;
a control processor for controlling the operation of said postage meter, security device, printer, and communication interlink according to algorithms stored in a memory;
a memory operatively connected to said control processor for storing said algorithms, said algorithms adapted to provide at least a shipping function, an address function, and an accounting function; and
wherein said memory is constructed to store a address data available for printing and accounting data for said franking meter.

2. A franking system, according to claim 1, wherein said address function includes communicating with an external database of addresses and checking the accuracy of addresses selected for printing on a mail item.

3. A franking system, according to claim 1, wherein said address data includes, destination information, routing, delivery, and tracking codes.

4. A franking system, according to claim 1, wherein said memory is constructed to store customer accounts.

5. A franking system, according to claim 1, wherein said memory includes a read-only memory modules for storing address data in process.

6. A franking system, according to claim 1, wherein said communication link is a modem for connecting to an Internet server and said database of accurate address data is accessible by means of said Internet server.

7. A franking system, according to claim 1, wherein said communication link is a modem for connecting to an third party server and said database of accurate address data is accessible by means of a direct secure phone line.

8. A franking system, according to claim 1, wherein said communication link is constructed to connect to a personal digital assistant for connecting to the Internet.

9. A franking system, according to claim 1, wherein said communication link is constructed to connect to a personal computer for connecting to the Internet or third party server.

10. A method of operating a franking system comprising the steps of:
feeding a mail item to a printer;
entering security codes into a postal security device;
verifying the authenticity of said security codes;
if said security codes are authorized, selecting at least one address from an internal address database for application to said mail item;
verifying the accuracy of said selected address;
if said address is accurate, calculating the shipping charges and printing the mail item or label with shipping charge indicium and address data;
if said address is inaccurate, correcting said address, entering said corrected address in said internal database, and calculating the shipping charges and printing the mail item or label with shipping charge indicium and address data.

11. A method of operating a franking machine, according to claim 10, wherein the step of verifying the accuracy of said selected address further comprises the steps of:
communicating with an external database of accurate addresses; and
comparing said selected address with data from said external database to determine the accuracy of the selected address.

12. A method of operating a franking machine, according to claim 11, wherein said external database is accessible through an Internet server.

13. A method of operating a franking machine, according to claim 11, wherein said external database is accessible directly through a phone line.

14. A method of operating a franking machine, according to claim 10, wherein said address is printed in accordance with predetermined shipping forms.

15. A method of operating a franking machine, according to claim 11, wherein said address data includes, destination information, routing, delivery, and tracking codes.

16. A franking system, according to claim 1, wherein said memory further stores commercial shipping forms for use in printing said address on said mail item.
